(19) United States
(12) Patent Application Publication
(10) Pub. No.: US 2017/0218747 A1
(43) Pub. Date: Aug. 3, 2017

(54) DETERMINING EXPECTED SENSOR VALUES FOR DRILLING TO MONITOR THE SENSOR

(71) Applicant: Schlumberger Technology Corporation, Sugar Land, TX (US)

(72) Inventor: Darren Lee Aklestad, Katy, TX (US)

(21) Appl. No.: 15/501,868

(22) PCT Filed: Jul. 30, 2015
(86) PCT No.: PCT/US2015/042895

§ 371 Date: Feb. 6, 2017

Related U.S. Application Data
(60) Provisional application No. 62/033,647, filed on Aug. 6, 2014.

(51) Int. Cl. E21B 44/00; E21B 47/022; G01V 3/38; G01V 13/00; G01V 3/08; G06F 9/455; G01V 7/02

(52) U.S. Cl. CPC E21B 44/005; G06F 9/455; E21B 47/022; G01V 7/02; G01V 13/00; G01V 3/08; G01V 3/38

(57) ABSTRACT

Aspects of the disclosure can relate to simulating expected sensor values associated with a drill tool (e.g., a drill assembly) before drilling to monitor the sensor. A planned trajectory for the drill assembly is received, where the planned trajectory is associated with a borehole to be drilled by the drill assembly along a geographic path. Next, an expected position for the drill assembly is determined along the geographic path. Then, an expected sensor value for a sensor associated with the drill assembly is simulated at the expected position. Next, an actual sensor value at an actual position corresponding to the expected position is determined. Then, the expected sensor value and the actual sensor value are dynamically displayed together at a user interface.

### CROSS-REFERENCE TO RELATED APPLICATIONS

This application claims priority to U.S. Provisional Patent Application Ser. No. 62/033647, which was filed on Aug. 6, 2014, and is incorporated herein by reference in its entirety.

### BACKGROUND

Oil wells are created by drilling a hole into the earth using a drilling rig that rotates a drill string (e.g., drill pipe) having a drill bit attached thereto. The drill bit, aided by the weight of pipes (e.g., drill collars) cuts into rock within the earth. Drilling fluid (e.g., mud) is pumped into the drill pipe and exits at the drill bit. The drilling fluid may be used to cool the bit, lift rock cuttings to the surface, at least partially prevent destabilization of the rock in the wellbore, and/or at least partially overcome the pressure of fluids inside the rock so that the fluids do not enter the wellbore.

### SUMMARY

Aspects of the disclosure can relate to a method for simulating expected sensor values associated with a drill tool (e.g., a drill assembly) before drilling, to monitor the sensor. A planned trajectory for the drill assembly is received, where the planned trajectory is associated with a borehole to be drilled by the drill assembly along a geographic path. An expected position for the drill assembly is determined along the geographic path. An expected sensor value for a sensor associated with the drill assembly is simulated at the expected position. Next, an actual sensor value at an actual position corresponding to the expected position is determined. Then, the expected sensor value and the actual sensor value are dynamically displayed together at a user interface.

Other aspects of the disclosure can relate to a system for simulating expected sensor values associated with a drill assembly before drilling to monitor the sensor. A memory is operable to store one or more modules. A processor is operably coupled to the memory, and the processor is operable to execute the one or more modules to receive a planned trajectory for the drill assembly, where the planned trajectory is associated with a borehole to be drilled by the drill assembly along a geographic path. The processor is also operable to execute the one or more modules to determine an expected position for the drill assembly along the geographic path, and simulate an expected sensor value for a sensor associated with the drill assembly at the expected position. The system can also include a sensor configured to determine an actual sensor value at an actual position corresponding to the expected position, and a user interface configured to dynamically display the expected sensor value and the actual sensor value together.

This summary is provided to introduce a selection of concepts that are further described below in the detailed description. This summary is not intended to identify key or essential features of the claimed subject matter, nor is it intended to be used as an aid in limiting the scope of the claimed subject matter.

### FIGURES

Embodiments of determining expected sensor values for a borehole are described with reference to the following figures.

FIG. 1 illustrates an example system in which embodiments of determining expected sensor values for a borehole can be implemented;

FIG. 2 illustrates an example system for determining expected sensor values for a borehole;

FIG. 3 is a table that illustrates example simulated sensor values in accordance with one or more embodiments; and

FIG. 4 illustrates an example method of determining expected sensor values for a borehole.

### DETAILED DESCRIPTION

Oil and gas well drilling operations can use sensors deployed down hole (e.g., as part of a drill string) to acquire information as a wellbore is being drilled. For example, during the drilling of a borehole, multiple sensor readings from down hole drilling tools are received at the surface. This real-time data can provide information about the progress of the drilling operation, earth formations surrounding the borehole, and so on. Operations personnel often monitor the measured values with a limited understanding of values that could be expected from the sensors when following the prescribed well trajectory. Further, the range of acceptable values of these sensor readings can be a function of various factors, including, but not necessarily limited to geographic factors, geometric factors, geophysical conditions, and so forth. Variations of operator training and/or experience levels may result in incorrect conclusions regarding tool performance (e.g., based upon operator interpretation of the sensor values). Thus, in some cases, sensor values received from correctly functioning tools may be interpreted as indicative of tool failure (e.g., when unexpected changes are observed in sensor values, sensor value changes do not follow expectations, and so on). For instance, a cause of sensor value misinterpretation can be the complexity of dynamically changing spatial relations between wellbore trajectory and gravity and/or geomagnetic fields.

Systems and methods for wellbore magnetic surveying are described herein that can provide specific monitoring guidance information for operations personnel during borehole trajectory planning activities. Reducing and/or eliminating misinterpretation of survey sensor data by presenting expected sensor values for a correctly operating tool and a reasonably followed planned trajectory can be provided to a drilling equipment operator. As described herein, planned borehole trajectory orientations and modeled geophysical values of geomagnetic field data and/or gravity field data can be used to generate expected values that a down hole surveying tool may measure on multi-axis accelerometers, magnetometers, and so forth. Specific sensor value ranges can be provided along the planned trajectory of a drill assembly, which can be compared to measured sensor readings determined during drilling. The expected values generated can be used during wellbore construction by personnel to verify that actual measured sensor values are in an expected range as defined by the generated values from the plan. This technique can reduce or eliminate misinterpretation of measured data as erroneous (e.g., due to simplification of the complex spatial relationship between the down hole survey tool orientation and the geophysical field orientations). As described herein, drilling applications are provided by way of example and are not meant to limit the present disclosure. In other embodiments, systems, techniques, and apparatus as described herein can be used with other down hole operations. Further, such systems, techniques, and apparatus can be used in other applications not necessarily related to down hole operations.

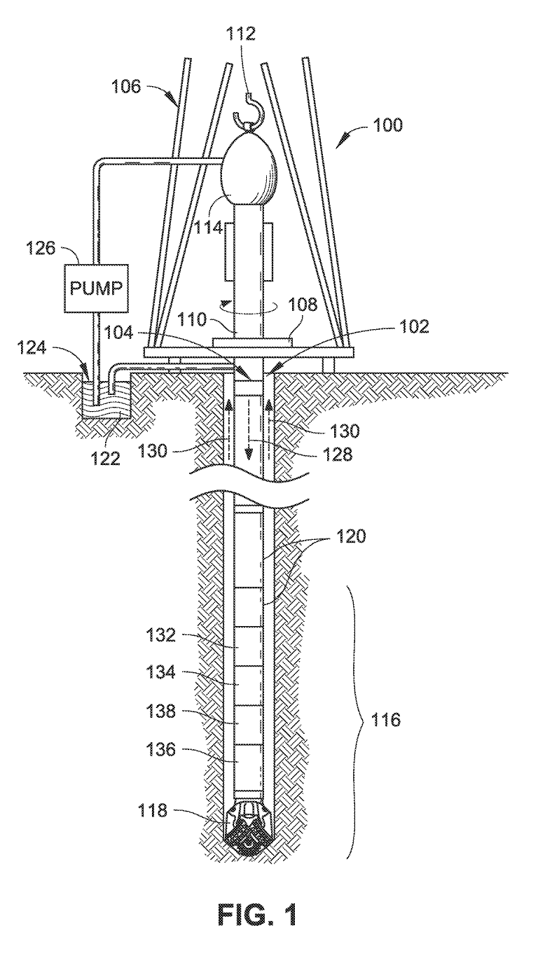

FIG. 1 depicts a wellsite system 100 in accordance with one or more embodiments of the present disclosure. The wellsite can be onshore or offshore. A borehole 102 is formed in subsurface formations by directional drilling. A drill string 104 extends from a drill rig 106 and is suspended within the borehole 102. In some embodiments, the wellsite system 100 implements directional drilling using a rotary steerable system (RSS). For instance, the drill string 104 is rotated from the surface, and down hole devices move the end of the drill string 104 in a desired direction. The drill rig 106 includes a platform and derrick assembly positioned over the borehole 102. In some embodiments, the drill rig 106 includes a rotary table 108, kelly 110, hook 112, rotary swivel 114, and so forth. For example, the drill string 104 is rotated by the rotary table 108, which engages the kelly 110 at the upper end of the drill string 104. The drill string 104 is suspended from the hook 112 using the rotary swivel 114, which permits rotation of the drill string 104 relative to the hook 112. However, this configuration is provided by way of example and is not meant to limit the present disclosure. For instance, in other embodiments a top drive system is used.

A bottom hole assembly (BHA) 116 is suspended at the end of the drill string 104. The bottom hole assembly 116 includes a drill bit 118 at its lower end. In embodiments of the disclosure, the drill string 104 includes a number of drill pipes 120 that extend the bottom hole assembly 116 and the drill bit 118 into subterranean formations. Drilling fluid (e.g., mud) 122 is stored in a tank and/or a pit 124 formed at the wellsite. The drilling fluid 122 can be water-based, oil-based, and so on. A pump 126 displaces the drilling fluid 122 to an interior passage of the drill string 104 via, for example, a port in the rotary swivel 114, causing the drilling fluid 122 to flow downwardly through the drill string 104 as indicated by directional arrow 128. The drilling fluid 122 exits the drill string 104 via ports (e.g., courses, nozzles) in the drill bit 118, and then circulates upwardly through the annulus region between the outside of the drill string 104 and the wall of the borehole 102, as indicated by directional arrows 130. In this manner, the drilling fluid 122 cools and lubricates the drill bit 118 and carries drill cuttings generated by the drill bit 118 up to the surface (e.g., as the drilling fluid 122 is returned to the pit 124 for recirculation). Further, destabilization of the rock in the wellbore can be at least partially prevented, the pressure of fluids inside the rock can be at least partially overcome so that the fluids do not enter the wellbore, and so forth.

In embodiments of the disclosure, the drill bit 118 comprises one or more crushing and/or cutting implements, such as conical cutters and/or bit cones having spiked teeth (e.g., in the manner of a roller-cone bit). In this configuration, as the drill string 104 is rotated, the bit cones roll along the bottom of the borehole 102 in a circular motion. As they roll, new teeth come in contact with the bottom of the borehole 102, crushing the rock immediately below and around the bit tooth. As the cone continues to roll, the tooth then lifts off the bottom of the hole and a high-velocity drilling fluid jet strikes the crushed rock chips to remove them from the bottom of the borehole 102 and up the annulus. As this occurs, another tooth makes contact with the bottom of the borehole 102 and creates new rock chips. In this manner, the process of chipping the rock and removing the small rock chips with the fluid jets is continuous. The teeth intermesh on the cones, which helps clean the cones and enables larger teeth to be used. A drill bit 118 comprising a conical cutter can be implemented as a steel milled-tooth bit, a carbide insert bit, and so forth. However, roller-cone bits are provided by way of example and are not meant to limit the present disclosure. In other embodiments, a drill bit 118 is arranged differently. For example, the body of the drill bit 118 comprises one or more polycrystalline diamond compact (PDC) cutters that shear rock with a continuous scraping motion.

In some embodiments, the bottom hole assembly 116 includes a logging-while-drilling (LWD) module 132, a measuring-while-drilling (MWD) module 134, a rotary steerable system 136, a motor, and so forth (e.g., in addition to the drill bit 118). The logging-while-drilling module 132 can be housed in a drill collar and can contain one or a number of logging tools. It should also be noted that more than one LWD module and/or MWD module can be employed (e.g. as represented by another logging-while-drilling module 138). In embodiments of the disclosure, the logging-while drilling modules 132 and/or 138 include capabilities for measuring, processing, and storing information, as well as for communicating with surface equipment, and so forth.

The measuring-while-drilling module 134 can also be housed in a drill collar, and can contain one or more devices for measuring characteristics of the drill string 104 and drill bit 118. The measuring-while-drilling module 134 can also include components for generating electrical power for the down hole equipment. This can include a mud turbine generator powered by the flow of the drilling fluid 122. However, this configuration is provided by way of example and is not meant to limit the present disclosure. In other embodiments, other power and/or battery systems can be employed. The measuring-while-drilling module 134 can include one or more of the following measuring devices, a direction measuring device, an inclination measuring device, and so on. Further, a logging-while-drilling module 132 and/or 138 can include one or more measuring devices, such as a weight-on-bit measuring device, a torque measuring device, a vibration measuring device, a shock measuring device, a stick slip measuring device, and so forth.

In some embodiments, the wellsite system 100 is used with controlled steering or directional drilling. For example, the rotary steerable system 136 is used for directional drilling. As used herein, the term “directional drilling” describes intentional deviation of the wellbore from the path it would naturally take. Thus, directional drilling refers to steering the drill string 104 so that it travels in a desired direction. In some embodiments, directional drilling is used for offshore drilling (e.g., where multiple wells are drilled from a single platform). In other embodiments, directional drilling enables horizontal drilling through a reservoir, which enables a longer length of the wellbore to traverse the reservoir, increasing the production rate from the well. Further, directional drilling may be used in vertical drilling operations. For example, the drill bit 118 may veer off of a planned drilling trajectory because of the unpredictable nature of the formations being penetrated or the varying forces that the drill bit 118 experiences. When such deviation occurs, the wellsite system 100 may be used to guide the drill bit 118 back on course.

The drill string 104 can include one or more extendable displacement mechanisms, such as a piston mechanism that can be selectively actuated by an actuator to displace a pad toward, for instance, a borehole wall to cause the bottom hole assembly 116 to move in a desired direction of deviation. In embodiments of the disclosure, a displacement mechanism can be actuated by the drilling fluid 122 routed through the drill string 104. For example, the drilling fluid 122 is used to move a piston, which changes the orientation of the drill bit 118 (e.g., changing the drilling axis orientation with respect to a longitudinal axis of the bottom hole assembly 116). The displacement mechanism may be employed to control a directional bias and/or an axial orientation of the bottom hole assembly 116. Displacement mechanisms may be arranged, for example, to point the drill bit 118 and/or to push the drill bit 118. In some embodiments, a displacement mechanism is deployed by a drilling system using a rotary steerable system 136 that rotates with a number of displacement mechanisms. It should be noted that the rotary steerable system 136 can be used in conjunction with stabilizers, such as non-rotating stabilizers, and so on.

In some embodiments, a displacement mechanism can be positioned proximate to the drill bit 118. However, in other embodiments, a displacement mechanism can be positioned at various locations along a drill string, a bottom hole assembly, and so on. For example, in some embodiments, a displacement mechanism is positioned in a rotary steerable system 136, while in other embodiments, a displacement mechanism can be positioned at or near the end of the bottom hole assembly 116 (e.g., proximate to the drill bit 118). In some embodiments, the drill string 104 can include one or more filters that filter the drilling fluid 122 (e.g., upstream of the displacement mechanism with respect to the flow of the drilling fluid 122).

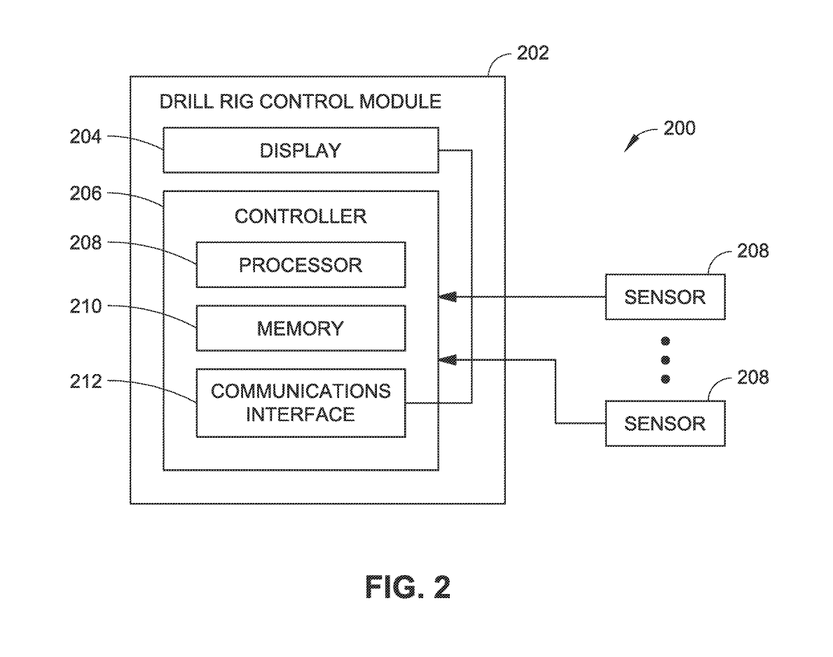

Referring now to FIG. 2, example systems and devices are described that can present simulated expected sensor values for down hole operations, such as drilling operations that use sensors deployed down hole. A system 200 includes a control module (e.g., a drill rig control module 202) with a user interface (e.g., a display 204, such as an electronic display) for displaying sensor values, expected sensor values, and so forth. In embodiments, the display 204 can be presented to an operator of the monitored equipment. In some embodiments, the display 204 can be located at, for example, a drill rig. However, in other embodiments, a display 204 can be at a remote location. For instance, the display 204 can be implemented using a system that hosts software and/or associated data in the cloud. The software can be accessed by a client device (e.g., a mobile device) with a thin client (e.g., via a web browser). The operator can compare a displayed sensor value to an expected value and/or a range of expected sensor values to determine whether the monitored equipment and/or sensors are functioning correctly. The display 204 can be coupled to a controller 206, which can operate to display sensor values, expected sensor values, and so forth on the display 204.

The controller 206 can be coupled with one or more sensors 208, which can report determined values associated with a monitored operation, such as a drilling operation, to the controller 206. Example sensors 208 can include, but are not necessarily limited to: sensors associated with a logging-while-drilling module 132/138, a measuring-while-drilling module 134, a rotary steerable system 136, a drill bit 118, a motor, and so forth. For example, a measuring-while-drilling module 134 housed in a drill collar contains one or more sensors 208 for measuring characteristics of the drill string 104 and/or the drill bit 118. One or more of the sensors 208 can be coupled with the controller 206 and can communicate sensed values associated with the drill string 104 and/or the drill bit 118 to the controller 206.

In some embodiments, the system 200 includes an alert module. The alert module can be configured to provide an alert to an operator when a condition (or set of conditions) is met for monitored equipment. For example, an alert is generated when a sensor value is outside a range of expected values. In some embodiments, an alert is provided to an operator in the form of an audible and/or visual alarm. However, these alerts are provided by way of example and are not meant to limit the present disclosure. In other embodiments, different alerts are provided to an operator. For instance, an alert can be provided to an operator in the form of an email message, a text message, and so forth. Further, multiple alerts can be provided to an operator when a condition is met for the monitored equipment (e.g., an email message and a text message, and so forth).

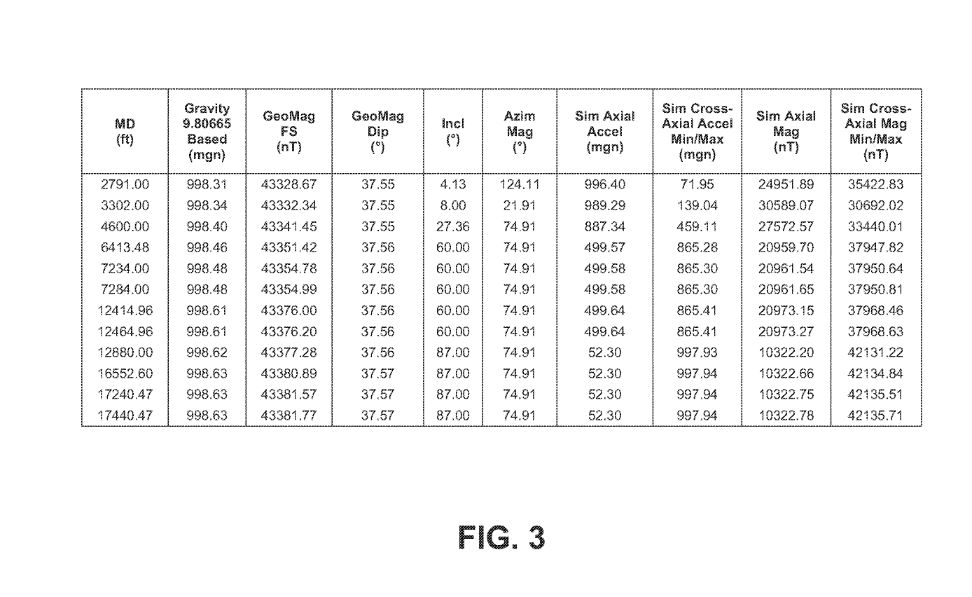

In example embodiments, the following equations can be used to simulate expected sensor values for a drilling assembly (e.g., a down hole drilling tool that includes one or more sensors, a drill tool, and so forth, such as the wellsite system 100 described with reference to FIG. 1). In some embodiments, this technique can be used repeatedly (e.g., for each reported survey station) to describe the prescribed borehole trajectory to be drilled. For the purposes of the present disclosure, the term “survey station” shall be defined as a specific depth location along the borehole path. The simulated values can then be recorded on reports and/or within computing systems used during the drilling of the planned trajectory (e.g., as shown in FIG. 3). As described herein, expected sensor values can be presented in units appropriate for the measurement tool sensors being used for the measuring of acceleration and/or magnetic field strength (e.g., magnetic flux density) in the field (e.g., meters per second-squared (m/s²) and/or milli-g's for acceleration, nano-Tesla (nT) and/or Gauss (G) for magnetic flux density, and so on).

Primary Output
Gₐₓᵢₐₗ Axial accelerometer reading
G_{cross-axial (min,max)} Cross-axial accelerometer reading range
Bₐₓᵢₐₗ Axial magnetometer reading
B_{cross-axial (min,max)} Cross-axial magnetometer reading range

Primary Input
G_{ref} Reference acceleration of gravity value
Bᵣₑ Reference magnetic field strength value
dip_{ref} Reference magnetic field dip angle
inc Planned wellbore trajectory inclination angle
azi_{mag} Planned wellbore trajectory azimuth angle referenced to magnetic North

Axial Accelerometer Reading—to be Reported
Gₐₓᵢₐₗ=G_{ref}*cos(inc)

Cross-Axial Accelerometer Reading Range—to be Reported
G_{cross-axial (min,max)}=±G_{ref}*sin(inc)

B_{horz}=B_{ref}*cos(dip_{ref})

Bᵥₑᵣₜ=B_{ref}*sin(dip_{ref})

Axial Magnetometer Reading—to be Reported
Bₐₓᵢₐₗ=B_{horz}*sin(inc)*cos(azi_{mag})+Bᵥₑᵣₜ*cos(inc)

B_{y temp}=B_{horz}*cos(inc)*cos(azi_{mag})−Bᵥₑᵣₜ*sin(inc)

B_{z temp}=−B_{horz}*sin(azi_{mag})

T F_{(min,max)}=a tan 2(B_{y temp}, B_{z temp})

Note: this is the quadrant correct tangent

Cross-Axial Magnetometer Reading Range—to be Reported
B_{cross-axial (min,max)}=±(B_{y temp}*cos(TF_{(min,max)})+B_{z temp}*sin(TF_{(min,max)}))

In some embodiments, expected sensor values are determined that account for an actual drilling operation deviating from a planned borehole trajectory, resulting in a range of simulated values. For example, deviation from a planned path can be accounted for by running multiple simulations to generate a valid range for the axial sensors and/or a different range for the cross-axial sensors. The same equations can also be used to produce values corresponding to survey stations that deviate from the planned (e.g., ideal) trajectory orientation to simulate reasonable deviations of actual drilling from the planned trajectory, providing a wider range of values.

The following is an example calculation using techniques in accordance with the present disclosure.

Primary Input
G_{ref}=998.3135 Reference acceleration of gravity value
B_{ref}=43328.6736 Reference magnetic field strength value
dip_{ref}=37.5518 Reference magnetic field dip angle
inc=4.13 Planned wellbore trajectory inclination angle
azi_{mag}=124.1115 Planned wellbore trajectory azimuth angle referenced to magnetic North

Axial Accelerometer Reading—to be Reported
Gₐₓᵢₐₗ=998.3135*cos(4.13)=996.3968(milli-g)

Cross-Axial Accelerometer Reading Range—to be Reported
G_{cross-axial (min,max)}=±998.3135*sin(4.13)=71.9470(milli-g)

B_{horz}=43328.6736*cos(37.5518)=34351.0871(nT)

Bᵥₑᵣₜ=43328.6736*sin(37.5518)=26407.8922(nT)

Axial Magnetometer Reading—to be Reported
Bₐₓᵢₐₗ=34351.0871*sin(4.13)*cos(124.1115)+26407.8922*cos(4.13)=24951.8921(nT)

B_{y temp}=34351.0871*cos(4.13)*cos(124.1115)−26407.8922* sin(4.13)=−21116.1308(nT)

B_{z temp}=−34351.0871*sin(124.1115)=−28440.9067(nT)

TF_{(min,max)}=a tan 2(−21116.1308, −28440.9067)=−26.5923(deg)

Note: this is the quadrant correct tangent

Cross-Axial Magnetometer Reading Range—to be Reported
B_{cross-axial (min,max)}=±(−21116.1308*cos(−126.5923)+ −28440.9067* sin(−126.5923))=35422.8312(nT)

As described herein, expected sensor data trends can also be ascertained (e.g., increasing, decreasing, generally stable, stable, and so forth), as well as expected polarity reversals, which can be the result of the changing spatial relationship between the borehole and the geophysical measurement fields. These expected sensor data trends can be derived from graphical and/or numerical presentation of the simulation data. Further, such trends can be recorded on reports and/or within computing systems used during the drilling of the planned trajectory (e.g., as previously described).

In example embodiments, a range of expected sensor values for sensor readings can be determined based upon one or more conditions including, but not necessarily limited to, geographic conditions, geometric conditions, geophysical conditions, and so forth. Thus, in some embodiments a range can be determined based upon a rotational orientation of a tool, which can create varied readings with respect to geographic, geometric, and/or geophysical conditions. Further, a range can be reported as a maximum expected value and a minimum expected value, and may also include intermediate values, such as mean and/or median expected values. However, such conditions are provided by way of example and are not meant to limit the present disclosure. In other embodiments, a range can be determined based upon allowable deviations from a planned trajectory. For example, an expected sensor value or range of expected sensor values can be converted to another range of expected sensor values by adding and/or subtracting a percentage of an expected sensor value or range of expected sensor values. For instance, an expected sensor value can be reported as a range of expected sensor values determined based upon the expected sensor value plus or minus two-percent (+/−2%). In another example, a range of expected sensor values can be expanded (e.g., adding and/or subtracting a percentage to maximum and/or minimum expected sensor values). In this manner, expected sensor values and/or ranges of expected sensor values can be used for quality control (QC) (e.g., to ensure that sensors are working correctly and not malfunctioning). Such expected sensor values can also be used to avoid misinterpretation of sensor readings by operations personnel.

Referring now to FIG. 2, a system 200, including some or all of its components, can operate under computer control. For example, a processor can be included with or in a system 200 to control the components and functions of systems 200 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 200. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The controller 206 can include a processor 208, a memory 210, and a communications interface 212. The processor 208 provides processing functionality for the controller 206 and can include any number of processors, micro-controllers, or other processing systems, and resident or external memory for storing data and other information accessed or generated by the controller 206. The processor 208 can execute one or more software programs that implement techniques described herein. The processor 208 is not limited by the materials from which it is formed or the processing mechanisms employed therein and, as such, can be implemented via semiconductor(s) and/or transistors (e.g., using electronic integrated circuit (IC) components), and so forth.

The memory 210 is an example of tangible, computer-readable storage medium that provides storage functionality to store various data associated with operation of the controller 206, such as software programs and/or code segments, or other data to instruct the processor 208, and possibly other components of the controller 206, to perform the functionality described herein. Thus, the memory 210 can store data, such as a program of instructions for operating the system 200 (including its components), and so forth. It should be noted that while a single memory 210 is described, a wide variety of types and combinations of memory (e.g., tangible, non-transitory memory) can be employed. The memory 210 can be integral with the processor 208, can comprise stand-alone memory, or can be a combination of both.

The memory 210 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the drill rig control module 202 and/or the memory 210 can include removable integrated circuit card (ICC) memory, such as memory provided by a subscriber identity module (SIM) card, a universal subscriber identity module (USIM) card, a universal integrated circuit card (UICC), and so on.

The communications interface 212 is operatively configured to communicate with components of the system 200. For example, the communications interface 212 can be configured to transmit data for storage in the system 200, retrieve data from storage in the system 200, and so forth. The communications interface 212 is also communicatively coupled with the processor 208 to facilitate data transfer between components of the system 200 and the processor 208 (e.g., for communicating inputs to the processor 208 received from a device communicatively coupled with the controller 206, such as a sensor 208). It should be noted that while the communications interface 212 is described as a component of a controller 206, one or more components of the communications interface 212 can be implemented as external components communicatively coupled to the system 200 via a wired and/or wireless connection. The controller 206 can also comprise and/or connect to one or more input/output (I/O) devices (e.g., via the communications interface 212), including, but not necessarily limited to: the display 204, a mouse, a touchpad, a keyboard, and so on.

The communications interface 212 and/or the processor 208 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 212 can be configured to communicate with a single network or multiple networks across different access points.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

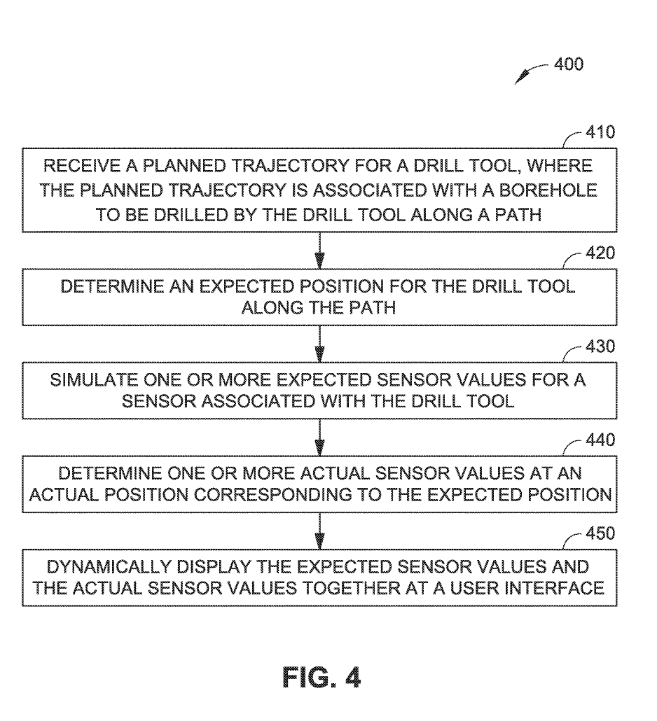

Referring now to FIG. 4, a procedure 400 is described in an example embodiment in which expected sensor values are determined for a borehole and compared to actual sensor values. At block 410, a planned trajectory for a drill tool, such as the drill string 104, is received, where the planned trajectory is associated with a borehole to be drilled by the drill tool along a path, such as the borehole 102. At block 420, an expected position for the drill tool along the path is determined. For example, the controller 206 determines an expected position for the drill string 104. At block 430, one or more expected sensor values for a sensor associated with the drill tool are simulated at the expected position. For instance, the controller 206 simulates one or more expected sensor values for one or more sensors 208. At block 440, one or more actual sensor values are determined at an actual position corresponding to the expected position. For example, actual sensor values from one or more sensors 208 are communicated to the controller 206 when the sensors 208 are at the expected position. At block 450, the expected sensor value or values and the actual sensor value or values are dynamically displayed together at a user interface, such as the display 204. It should be noted that for the purposes of the disclosure, dynamically displaying an expected sensor value or values together with an actual sensor value or values encompasses both displaying such values separately on the display 204 (e.g., side-by-side), as well as displaying a single value that can represent multiple values, such as a percentage difference between an actual sensor value and an expected sensor value (e.g., a plus two-percent (+2%) value). Further, it should be noted that a displayed value can include a numerical representation of a value, a graphical representation of a value, and/or a pictorial representation of a value, including, but not necessarily limited to: a number, a point on a graph, a bar on a graph of a specific height, an area on a graph of a specific size, and so forth.

Although only a few example embodiments have been described in detail above, those skilled in the art will readily appreciate that many modifications are possible in the example embodiments without materially departing from determining expected sensor values for a borehole. Features shown in individual embodiments referred to above may be used together in combinations other than those which have been shown and described specifically. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A method for simulating at least one expected sensor value associated with a drill assembly before drilling to monitor the sensor, the method comprising:
receiving a planned trajectory for the drill assembly, the planned trajectory associated with a borehole to be drilled by the drill assembly along a geographic path;
determining an expected position for the drill assembly along the geographic path;
simulating at least one expected sensor value for a sensor associated with the drill assembly at the expected position;
determining an actual sensor value at an actual position corresponding to the expected position; and
dynamically displaying the at least one expected sensor value and the actual sensor value together at a user interface.

2. The method as recited in claim 1, wherein simulating at least one expected sensor value for a sensor associated with the drill assembly at the expected position comprises simulating a range of expected sensor values.

3. The method as recited in claim 1, wherein the at least one expected sensor value is simulated with respect to a gravity field, and the at least one expected sensor value comprises at least one expected axial accelerometer sensor value determined using a reference acceleration of gravity value.

4. The method as recited in claim 3, wherein the at least one expected axial accelerometer sensor value comprises a range of expected axial accelerometer sensor values for a cross-axial accelerometer sensor.

5. The method as recited in claim 1, wherein the at least one expected sensor value is simulated with respect to at least one earth field comprising a geomagnetic field, and the at least one expected sensor value comprises at least one expected magnetometer sensor value determined using at least one of a reference magnetic field strength or a reference magnetic field dip angle.

6. The method as recited in claim 5, wherein the at least one expected magnetometer sensor value comprises a range of expected magnetometer sensor values for a cross-axial magnetometer sensor.

7. The method as recited in claim 1, further comprising determining a second expected position for the drill assembly along the geographic path, and simulating at least a second expected sensor value for the sensor at the second expected position.

8. The method as recited in claim 7, wherein the first expected position comprises a first rotational orientation and the second expected position comprises a second rotational orientation, and the first expected position and the second expected position both correspond to the same survey station.

9. The method as recited in claim 7, further comprising comparing the expected sensor value to the second expected sensor value, and determining at least one of a presence or an absence of an expected polarity reversal based upon the comparison.

10. A system for simulating at least one expected sensor value associated with a drill assembly before drilling to monitor the sensor, the system comprising:
a memory operable to store one or more modules; and
a processor operably coupled to the memory, the processor operable to execute the one or more modules to:
receive a planned trajectory for the drill assembly, the planned trajectory associated with a borehole to be drilled by the drill assembly along a geographic path;
determine an expected position for the drill assembly along the geographic path;
simulate at least one expected sensor value for a sensor associated with the drill assembly at the expected position;
a sensor configured to determine an actual sensor value at an actual position corresponding to the expected position; and
a user interface configured to dynamically display the at least one expected sensor value and the actual sensor value together.

11. The system as recited in claim 10, wherein the processor is operable to execute the one or more modules to simulate at least one expected sensor value for a sensor associated with the drill assembly at the expected position by simulating a range of expected sensor values.

12. The system as recited in claim 10, wherein the at least one expected sensor value is simulated with respect to a gravity field, and the at least one expected sensor value comprises at least one expected axial accelerometer sensor value determined using a reference acceleration of gravity value.

13. The system as recited in claim 12, wherein the at least one axial expected accelerometer sensor value comprises a range of expected axial accelerometer sensor values for a cross-axial accelerometer sensor.

14. The system as recited in claim 10, wherein the at least one expected sensor value is simulated with respect to at least one earth field comprising a geomagnetic field, and the at least one expected sensor value comprises at least one expected magnetometer sensor value determined using at least one of a reference magnetic field strength or a reference magnetic field dip angle.

15. The system as recited in claim 14, wherein the at least one expected magnetometer sensor value comprises a range of expected magnetometer sensor values for a cross-axial magnetometer sensor.

16. The system as recited in claim 10, wherein the processor is operable to execute the one or more modules to determine a second expected position for the drill assembly along the geographic path, and simulate at least a second expected sensor value for the sensor at the second expected position.

17. The system as recited in claim 16, wherein the first expected position comprises a first rotational orientation and the second expected position comprises a second rotational orientation, and the first expected position and the second expected position both correspond to the same survey station.

18. The system as recited in claim 16, wherein the processor is operable to execute the one or more modules to compare the expected sensor value to the second expected sensor value, and determine at least one of a presence or an absence of an expected polarity reversal based upon the comparison.

19. A method for simulating at least one expected sensor value associated with a drill tool before drilling to monitor the sensor, the method comprising:
receiving a planned trajectory for the drill tool, the planned trajectory associated with a borehole to be drilled by the drill tool along a path;
determining an expected position for the drill tool along the path;
simulating at least one expected sensor value for a sensor associated with the drill tool at the expected position;
determining an actual sensor value at an actual position corresponding to the expected position; and
dynamically displaying the at least one expected sensor value and the actual sensor value together at a user interface.

20. The method as recited in claim 19, wherein simulating at least one expected sensor value for a sensor associated with the drill tool at the expected position comprises simulating a range of expected sensor values.
